(19) United States
(12) Patent Application Publication
(10) Pub. No.: US 2020/0034809 A1
(43) Pub. Date: Jan. 30, 2020

(54) METHODS AND A TRANSACTION TERMINAL FOR TRANSACTION MERGE AND TRANSFER

(71) Applicant: NCR CORPORATION, Duluth, GA (US)

(72) Inventors: Ferdinand Salarda Acedera, Cebu City (PH); Jose Mari Cañete Velasco, Cebu City (PH)

(21) Appl. No.: 16/043,369

(22) Filed: Jul. 24, 2018

(51) Int. Cl. G06Q 20/20; G07G 1/01; G07G 1/00

(52) U.S. Cl. CPC G06Q 20/202; G07G 1/0009; G07G 1/01

(57) ABSTRACT

An in-progress transaction that is being processed on a first transaction terminal is dynamically transferred in real time for completion processing on a second transaction terminal. In an embodiment, an in-progress transaction that is being processed on a first transaction terminal is dynamically merged in real time with a second in-progress transaction being processed on a second transaction terminal.

### BACKGROUND

When a Point-Of-Sale (POS) terminal experiences a malfunction during a transaction, the transaction is typically voided and the failed transaction is forced to be processed on a different POS terminal. During high-traffic times at a store, such failures can be frustrating to consumers and to cashiers.

A customer associated with the failed transaction may be forced to go to a back of a queue at a different POS terminal with the customer's items in order to checkout. While the customer is gathering his items for moving to the different POS terminal queue, the original customers that were in the same queue as the customer may have already populated the other queues at the operational POS terminals. From the perspective of the cashiers at the operational POS terminal, pressure builds to reduce the queue sizes that have grown even larger because of the failed POS terminal.

Moreover, the POS terminal failure does not have to be a core failure, such that the POS terminal is completely inoperable until restored; rather and more likely, the failure occurs with respect to a peripheral of POS terminal, such as a scanner, payment card reader, cash drawer, a receipt printer, a produce weigh scale, etc. In fact, a variety of seemingly minor failures can cause a POS terminal to be unable to successfully complete a transaction for a customer.

Additionally, sometimes a customer desires to void a transaction at a POS terminal and add the customer's items that were voided to another transaction that is ongoing at a different POS terminal. This can occur for a variety of reasons, such as when family members are separately checking out, when friends are separately checking out, and/or when a Good Samaritan desires to pay for the items of someone known or unknown to them as a gesture of good will. Sometimes, the situation occurs when a customer lacks the funds for the items in the transaction and a friend or Good Samaritan offers to pay for the customer's items during checkout.

Presently, there is no mechanism by which such a situation can be handled other than the customer physically taking the items from the POS terminal to the different POS terminal, where the items are rescanned and processed with the items associated with the different transaction that is occurring on the different POS terminal. These situations can also create backups and longer queues at POS terminals within a store similar to what was discussed above when failures occur at POS terminals during checkouts.

### SUMMARY

In various embodiments, methods and a transaction terminal for transaction merge and transfer operations are presented.

According to an embodiment, a method for processing transaction transfer and transaction merge operations is presented. Specifically, and in one embodiment, a transaction operation request is identified for an in-progress transaction on a first transaction terminal. The in-progress transaction is suspended on the first transaction terminal responsive to the transaction operation request. Finally, transaction details for the in-progress transaction are transferred from the first transaction terminal to a second transaction terminal for completion processing on the second transaction terminal.

### BRIEF DESCRIPTION OF THE DRAWINGS

FIG. 1A is a diagram of a system for processing transaction transfer and transaction merge operations on multiple transaction terminals, according to an example embodiment.

FIG. 1B illustrates interface screens depicting an initiation of a transaction transfer from a source transaction terminal to a target transaction terminal, according to an example embodiment.

FIG. 1C illustrates interface screens depicting a request for receiving a transaction transfer from the source transaction terminal on the target transaction terminal, according to an example embodiment.

FIG. 1D illustrates interface screens depicting an acknowledgement on the source transaction terminal that the transaction was successfully transferred to the target transaction terminal, according to an example embodiment.

FIG. 1E illustrates interface screens depicting an initiation of a transaction merge from a source transaction terminal to a target transaction terminal, according to an example embodiment.

FIG. 1F illustrates interface screens from both the original source transaction terminal and the target transaction terminal following a successful transaction merge to the target transaction terminal, according to an example embodiment.

FIG. 2 is a diagram of a method for processing transaction transfer and transaction merge operations, according to an example embodiment.

FIG. 3 is a diagram of another method for processing transaction transfer and transaction merge operations, according to an example embodiment.

FIG. 4 is a transaction terminal for processing transaction transfer and transaction merge operations, according to an example embodiment.

### DETAILED DESCRIPTION

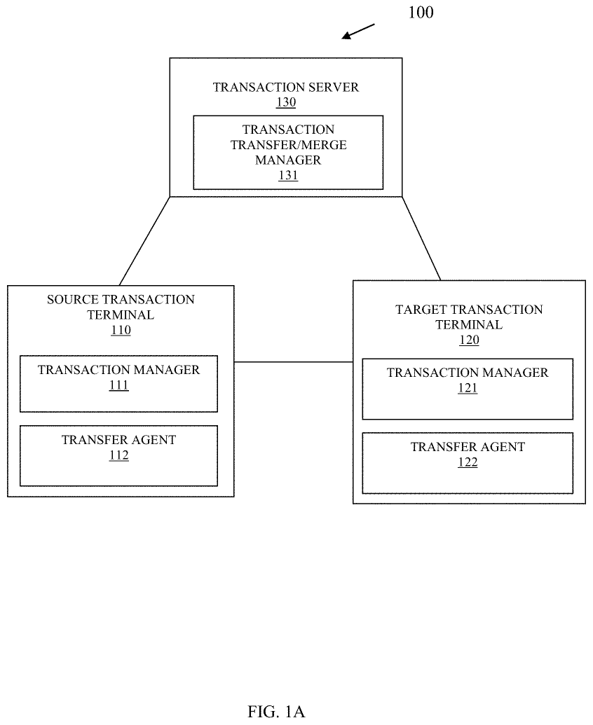

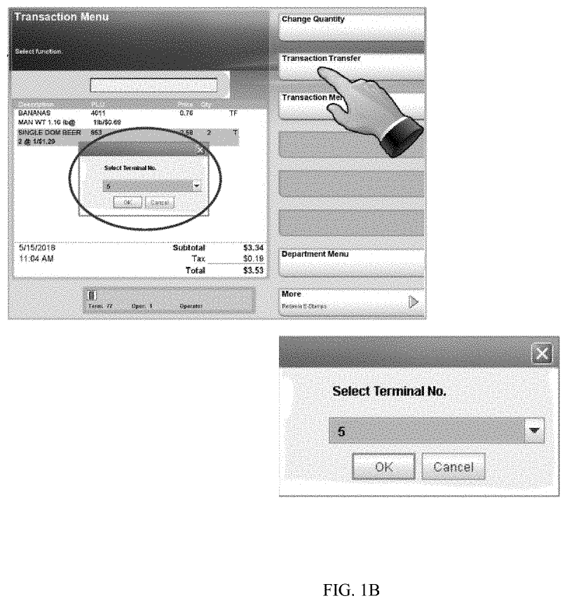

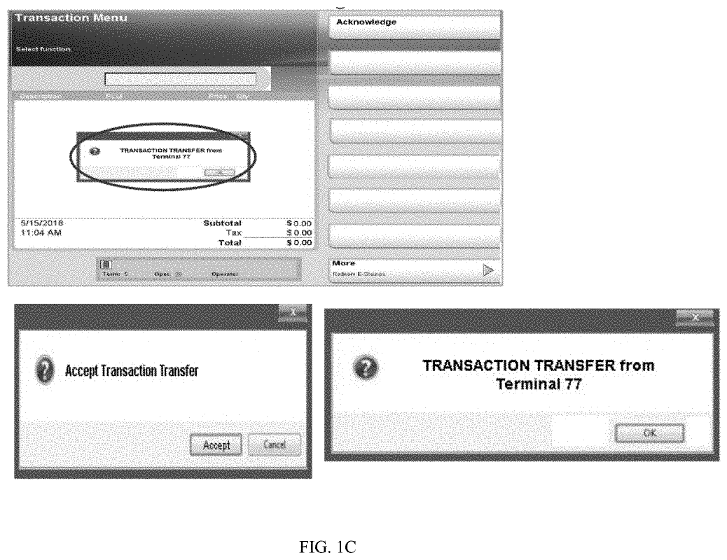

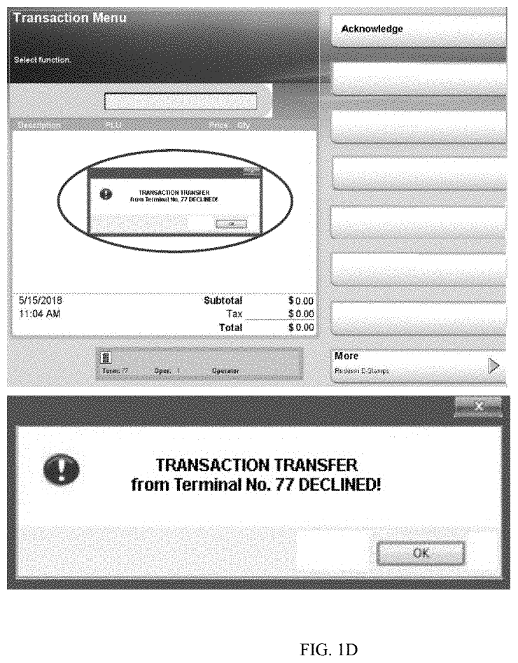

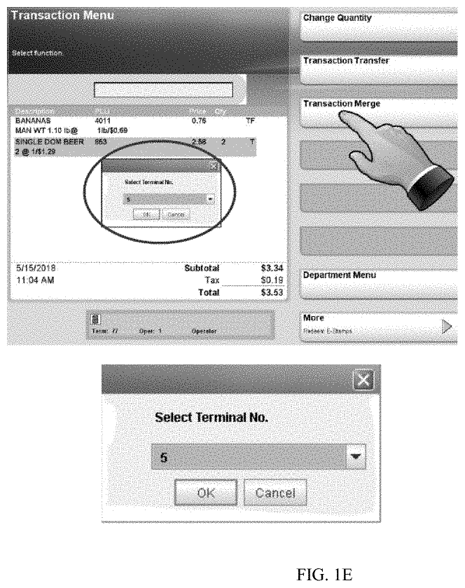

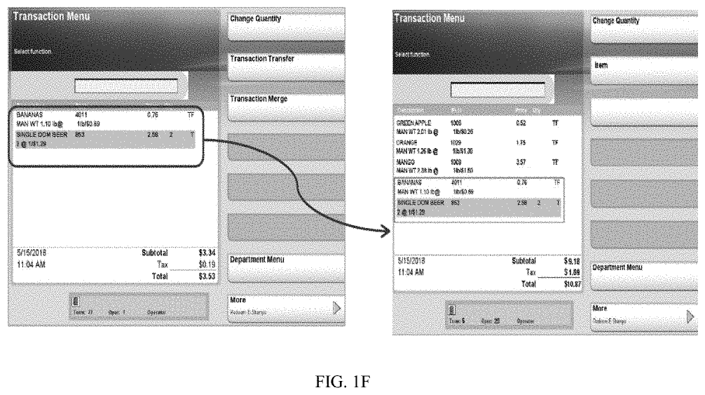

FIG. 1A is a diagram of a system 100 for processing transaction transfer and transaction merge operations on multiple transaction terminals, according to an example embodiment. It is to be noted that the components are shown schematically in greatly simplified form, with only those components relevant to understanding of the embodiments being illustrated.

Furthermore, the various components (that are identified in the FIG. 1A) are illustrated and the arrangement of the components is presented for purposes of illustration only. It is to be noted that other arrangements with more or less components are possible without departing from the teachings of transaction transfer and transaction merge operation processing, presented herein and below.

The system 100 includes a source transaction terminal 110 having a transaction manager 111 and a transfer agent 112. The system further includes at least one target transaction terminal 120 having a transaction manager 121 and a transfer agent. In an embodiment, and optionally, the system 100 further includes a transaction server 130 having a transaction transfer/merge manager 131.

The operator-facing interfaces of the transaction terminals 110 and 120 are enhanced to include operator-selectable options to perform transaction transfer and transaction merge operations. Furthermore, existing transaction managers of existing transaction terminals are enhanced as the presented transaction managers 111 and 121 for performing the transaction transfer and transaction merge operations discussed herein.

Some example interface screens rendered by the operator-facing interfaces of the transaction terminals 110 and 120 are provided in the FIGS. 1B-1F.

The operator of the transaction terminals 110 and 120 is presented within screens rendered from the operating-facing interfaces selectable options relevant to performing a transaction transfer from a source transaction terminal 110 for an in progress and ongoing transaction to a target transaction terminal 120.

Specifically, the FIG. 1B illustrates a source transaction terminal 110 selected option by an operator to transfer an ongoing transaction. Once selected, the operator-facing interface generates a popup screen where the operator of the source transaction terminal 110 can enter or select from a drop-down menu a specific target transaction terminal 120 (which is identified in the FIG. 1B as being the target transaction terminal 120 identified by the terminal identifier of the number 5).

The transaction manager 111, responsive to a transfer operation request, assembles the transaction details (such as, but not limited to, transaction identifier, item details, item pricing, customer identifier, coupons applied, loyalty points earned, loyalty points being redeemed, source transaction terminal identifier, date, time). The transaction manager 111 then temporarily suspends processing the transaction on the source transaction terminal 120 and provides the transaction details, the target transaction terminal identifier (5 in the FIG. 1B), and an identifier for the requested operation (here a transaction transfer operation identifier) to the transfer agent 112. The transfer agent 112 sends the transaction details with the transaction transfer operation identifier to the transfer agent 122 operational on the target transaction terminal 120 based on the target transaction terminal identifier (which identifies the target transaction terminal 120 to the transfer agent 112).

The transfer agent 122 provides the transaction details and the transaction transfer operation identifier to the transaction manager 121. The transaction manager 121 renders interface screens to an operator of the target transfer terminal 120 for accepting the transfer (an example of such screens is shown in the FIG. 1C). A popup window is presented on the display of the target transaction terminal indicating that a transaction transfer operation is being requested from the source transaction terminal (identified by the terminal identifier 77 and provided by the transfer agent 112 with the transaction details as discussed above). An additional popup window is also presented through the operating facing interface of the transaction terminal 121 providing the operator of the target transaction terminal 120 to accept or decline the transaction transfer request from the source transaction terminal 110.

Assuming the operator of the target transaction terminal accepts the transaction transfer request, the transaction manager 121 processes the transaction details provided and the transfer transaction continues and can be completed at the target transaction terminal 120. Simultaneously to accepting the transaction transfer request, the transaction manager 121 notifies the transfer agent 122 of the acceptance, and the transfer agent 122 provides a notice of acceptance back to the transfer agent 112 of the source transaction terminal 110. The transfer agent 112 notifies the transaction manager 111 of the source transaction terminal 110, and the transaction manager causes the operator-facing interface to present a popup window on the display of the source transaction terminal 110 indicating to the operator of the source transaction terminal 110 that the transaction was successfully transferred to the target transaction terminal 120. If the operator of the target transaction terminal 120 declines to accept the transaction transfer, then a decline message is presented in a popup window on the display of the source transaction terminal 110 (as shown in the FIG. 1D). In this case, the operator of the source transaction terminal 110 can select a different target transaction terminal for transferring the transaction and the processing discussed above is repeated with a different target transaction terminal identifier.

In an embodiment and for the transaction transfer operation, the source transfer agent 112 provides the transaction details, transaction transfer operation identifier, and target transaction terminal identifier to the transaction transfer/merge manager 131 through the transaction server 130. The transfer/merge manager 131 then communicates directly over a network connection with the target transfer agent 122 in the manners discussed above.

The FIG. 1E illustrates a selection by a source transaction terminal operator of a transaction merge operation to merge an existing, in progress, and ongoing transaction being processed on the source transaction terminal 110 to a second existing, in progress, and ongoing transaction being processed on the target transaction terminal 120. Again, a popup window permits the target transaction terminal identifier to be provided or selected from a dropdown menu by the source transaction terminal operator.

During the transaction merge operation, the interaction and processing of the transaction managers 111 and 121 and the transfer agents 112 and 122 are similar to that which was discussed above with the transaction transfer operation. However, the transaction operation identifier is for a transaction merge operation. So, a target transaction terminal operator sees a popup window to acknowledge and accept the transaction details from the transaction of the source transaction terminal with the existing transaction details for the pending transaction being processed on the target transaction terminal 120. The FIG. 1F illustrates a source transaction terminal screen (on the left in the FIG. 1F) for a source transaction being processed on the source transaction terminal 110 that is merged into a target transaction being processed on the target transaction terminal 120 as depicted in the target transaction terminal screen (on the right in the FIG. 1F).

Again, and in an embodiment, the transaction transfer/merge manager 131 of the server 130 may act as an intermediary between the two transfer agents 112 and 122 to process the transaction merge operation.

It is to be noted that although the processing was discussed as being from a source transaction terminal 110 to a target transaction terminal 120, each terminal 110 and 120 is capable of processing through its transaction manager 111 and 121 and its transfer agents 112 and 122 as a source terminal for any given transaction and as a target terminal for other transactions. In this way, the designation of source and target are dependent upon whether a terminal is initiating a transaction transfer or transaction merge in which case that terminal is the source transaction terminal 110 or whether a terminal is accepting a transaction transfer or transaction merge in which case that terminal is the target transaction terminal 120. Thus, for any given transaction a terminal 110 or 120 can be designated as the source terminal or the target terminal based on whether such terminal is requesting (source) or accepting (target).

In an embodiment, the processing of the transfer agents 112 and 121 are wholly subsumed as one processing module within their corresponding transaction managers 111 and 121.

In an embodiment, the transaction terminals 110 and 120 can be one or more of: a Point-Of-Sale (POS) terminal operated by a cashier and a Self-Service Terminal (SST) operated by a customer.

In an embodiment, the operators are one or more of: cashiers or customers performing SST transactions at SST.

In an embodiment, the operator of the source transaction terminal 110 is a customer and the source transaction terminal 110 is a SST while the second operator of the target transaction terminal 120 is a cashier and the target transaction terminal 120 is a POS terminal.

In an embodiment, both the source transaction terminal 110 and the target transaction terminal 120 are POS terminals operated by two different cashiers.

In an embodiment, both the source transaction terminal 110 and the target transaction terminal 120 are SST terminals operated by two different customers.

In an embodiment, the SST is one of: a self-service checkout station, a customer-operated phone, a customer-operated tablet, and a customer-operated wearable processing device.

In an embodiment, the POS terminal is one of: a checkout station, a cashier-operated phone, a cashier-operated tablet, and a cashier-operated wearable processing device.

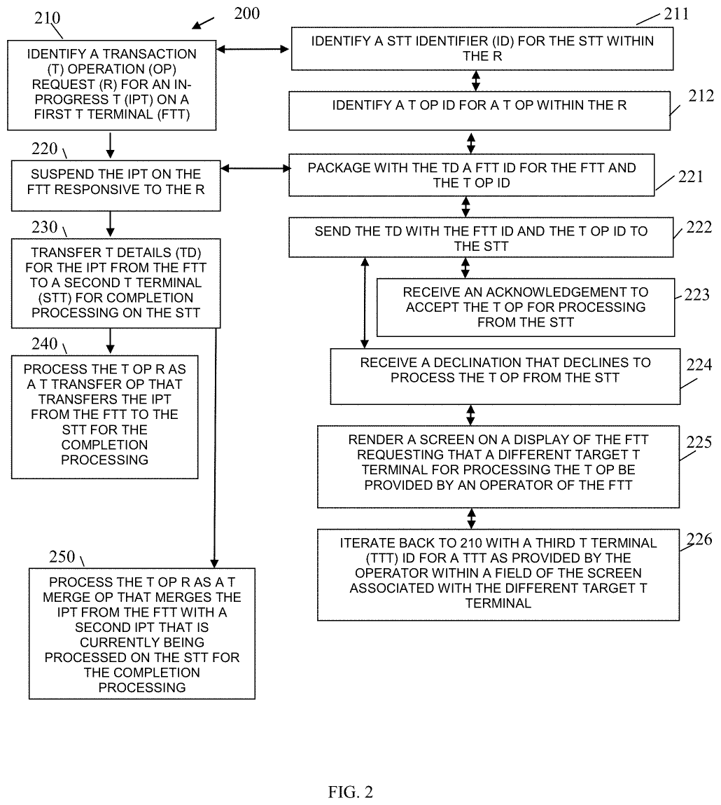

These and other embodiments are now discussed with reference to the FIGS. 2-4.

FIG. 2 is a diagram of a method 200 for processing transaction transfer and transaction merge operations, according to an example embodiment. The software module(s) that implements the method 200 is referred to as a “transaction transfer/merge agent.” The transaction transfer/merge agent is implemented as executable instructions programmed and residing within memory and/or a non-transitory computer-readable (processor-readable) storage medium and executed by one or more processors of a device. The processor(s) of the device that executes the transaction transfer/merge agent are specifically configured and programmed to process the transaction transfer/merge agent. The transaction transfer/merge agent has access to one or more network connections during its processing. The network connections can be wired, wireless, or a combination of wired and wireless.

In an embodiment, the device that executes the transaction transfer/merge agent is one of the transaction terminals 110 or 120. In an embodiment, the transaction terminal is a POS terminal. In an embodiment, the transaction terminal is a SST. In an embodiment, the POS terminal is one of: a cashier-operated checkout station, a cashier-operated phone, a cashier-operated tablet, and a cashier-operated wearable processing device. In an embodiment, the SST is one of: a self-service checkout station, a customer-operated phone, a customer-operated tablet, and a customer-operated wearable processing device.

In an embodiment, the transaction transfer/merge agent is the all or some combination of the transaction manager 111 and/or the transfer agent 112.

At 210, the transaction transfer/merge agent identify a transaction operation request for an in-progress transaction on a first transaction terminal. The transaction operation received during the in-progress transaction from an operator through an operator-facing interface (as discussed above with the FIGS. 1A-1F).

In an embodiment, at 211, the transaction transfer/merge agent identifies a second transaction terminal identifier for a second transaction terminal within the request.

In an embodiment of 211 and at 212, the transaction transfer/merge agent identifies a transaction operation identifier for a transaction operation within the request. This identifier can identify a transaction transfer operation or a transaction merge operation as discussed above with the FIGS. 1A-1F.

At 220, the transaction transfer/merge agent suspends the in-progress transaction from processing on the first transaction terminal responsive to identifying the request at 210.

In an embodiment of 212 and 220, at 221, the transaction transfer/merge agent packages with transaction details for the in-progress transaction, a first transaction terminal identifier for the first transaction terminal and a transaction operation identifier for the transaction operation.

In an embodiment of 221, at 222, the transaction transfer/merge agent sends the transaction details with the first transaction terminal identifier and the transaction operation identifier to the second transaction terminal.

In an embodiment of 222, at 223, the transaction transfer/merge agent receives an acknowledgement to accept the transaction operation for processing from the second transaction terminal.

In an embodiment of 222, at 224, the transaction transfer/merge agent receives a declination that declines to process the transaction operation from the second transaction terminal.

In an embodiment of 224, at 225, the transaction transfer/merge agent renders a screen on a display of the first transaction terminal requesting that a different target terminal for processing the transaction operation be provided by an operator of the first transaction terminal.

In an embodiment of 225, at 226, the transaction transfer/merge agent iterates back to 210 with a third transaction terminal identifier for a third transaction terminal as provided by the operator within a field of the screen that is associated with the different target transaction terminal.

At 230, the transaction transfer/merge agent transfers the transaction details for the in-progress transaction from the first transaction terminal to the second transaction terminal for completion processing on the second transaction terminal.

In an embodiment, at 240, the transaction transfer/merge agent processes the transaction operation request as a transaction transfer operation that transfers the in-progress transaction from the first transaction terminal to the second transaction terminal for the completion processing.

In an embodiment, at 250, the transaction transfer/merge agent processes the transaction operation request as a transaction merger operation that merges the in-progress transaction from the first transaction terminal with a second in-progress transaction that is currently being processed on the second transaction terminal for the completion processing.

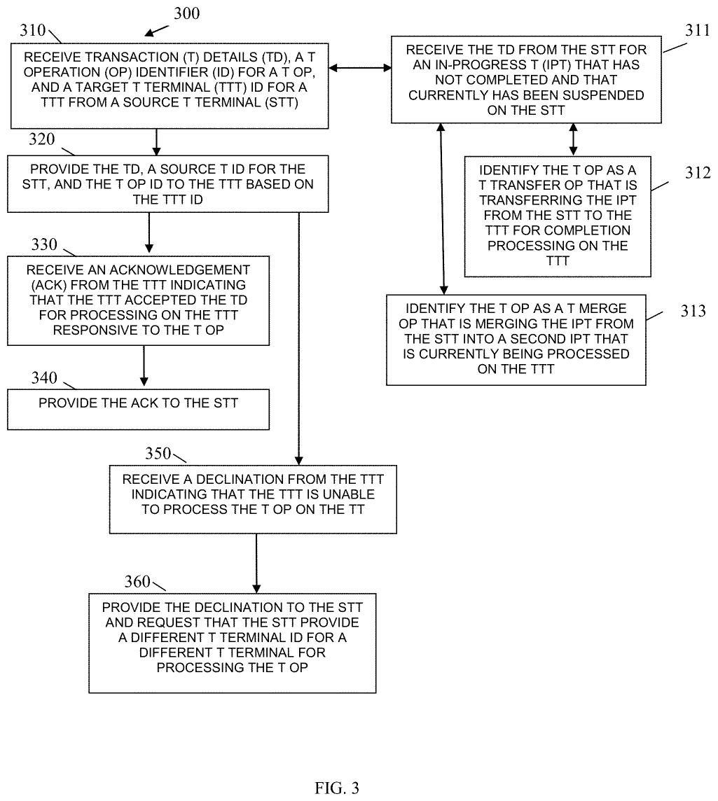

FIG. 3 is a diagram of another method 300 for processing transaction transfer and transaction merge operations, according to an example embodiment. The software module(s) that implements the method 300 is referred to as a “transaction transfer/merge manager.” The transaction transfer/merge manager is implemented as executable instructions programmed and residing within memory and/or a non-transitory computer-readable (processor-readable) storage medium and executed by one or more processors of a device. The processors that execute the transaction transfer/merge manager are specifically configured and programmed to process the transaction transfer/merge manager. The transaction transfer/merge manager has access to one or more network connections during its processing. The network connections can be wired, wireless, or a combination of wired and wireless.

In an embodiment, the device that executes the transaction transfer/merge manager is the transaction server 130. In an embodiment, the server 130 is a cloud processing environment that comprises multiple servers cooperating with one another as a single server.

In an embodiment, the transaction transfer/merge manager is transaction transfer/merge manager 131.

The transaction transfer/merge manager presents an embodiment for which transfer agents 112 and 121 coordinate transaction transfer operations and transaction merge operations through the transaction transfer/merge manager 131 of the transaction server 130.

At 310, the transaction transfer/merge manager receives transaction details, a transaction operation identifier for a transaction operation, and a target transaction terminal identifier for a target transaction terminal from a source transaction terminal.

In an embodiment, at 311, the transaction transfer/merge manager receives the transaction details from the source transaction terminal for an in-progress transaction that has not completed and that is currently suspended on the source transaction terminal.

In an embodiment of 311, at 312, the transaction transfer/merge manager identifies the transaction operation as a transaction transfer operation that is transferring the in-progress transaction from the source transaction terminal to the target transaction terminal for completion processing on the target transaction terminal.

In an embodiment of 311, at 313, the transaction transfer/merge manager identifies the transaction operation as a transaction merge operation that is merging the in-progress transaction from the source transaction terminal into a second in-progress transaction that is currently being processed on the target transaction terminal.

At 320, the transaction transfer/merge manager provides the transaction details, a source transaction terminal identifier for the source transaction terminal, and the transaction operation identifier to the target transaction terminal based on the target transaction terminal identifier.

In an embodiment, at 330, the transaction transfer/merge manager receives an acknowledgement from the target transaction terminal indicating that the target transaction terminal accepted the transaction details for processing on the target transaction terminal responsive to the transaction operation.

In an embodiment of 330, at 340, the transaction transfer/merge manager provides the acknowledgement to the source transaction terminal. In response, the source transaction terminal clears the in-progress transaction from the source transaction terminal.

In an embodiment, at 350, the transaction transfer/merge manager receives a declination from the target transaction terminal indicating that that the target transaction terminal is unable to process the transaction operation on the target transaction terminal.

In an embodiment of 350, at 360, the transaction transfer/merge manager provides the declination to the source transaction terminal and requests that the source transaction terminal provide a different transaction terminal identifier for a different transaction terminal for processing the transaction operation.

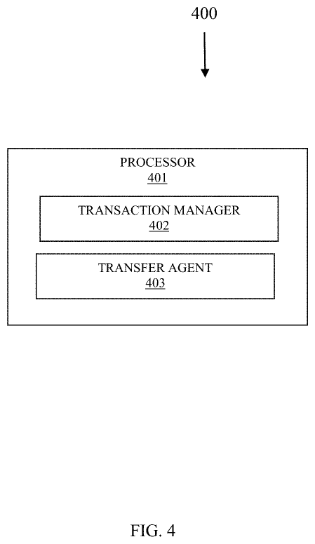

FIG. 4 is a diagram of a transaction terminal 400 for processing transaction transfer and transaction merge operations, according to an example embodiment. The transaction terminal 400 includes a variety of hardware components and software components. The software components of the transaction terminal 400 are programmed and reside within memory and/or a non-transitory computer-readable medium and execute on one or more processors of the transaction terminal 400. The transaction terminal 400 communicates over one or more networks, which can be wired, wireless, or a combination of wired and wireless.

In an embodiment, the transaction terminal 400 implements, inter alia, the processing described above with the FIGS. 1-2.

The transaction terminal 400 is one of the transaction terminals 110 or 120.

The transaction terminal 400 includes at least one hardware processor 401, a transaction manager 402, and a transfer agent 403.

The transaction manager 402 and the transfer agent 403 are executable instructions that reside in a non-transitory computer-readable storage medium and/or memory of the transaction terminal 400. The executable instructions are executed by the at least one hardware processor 401 of the transaction terminal 400.

In an embodiment, the transaction manager 402 is one of: the transaction manager 111 and the transaction manager 121.

In an embodiment, the transfer agent 403 is one of: the transfer agent 112 and the transfer agent 122.

In an embodiment, the transaction terminal 400 is a POS terminal. In an embodiment, the POS terminal is one of: a cashier-operated checkout terminal, a cashier-operated phone, a cashier-operated tablet, and a cashier-operated wearable processing device.

In an embodiment, the transaction terminal 400 is a SST terminal. In an embodiment, the SST is one of: a customer-operated checkout terminal, customer-operated phone, a customer-operated tablet, and a customer-operated wearable processing device.

The transaction manager 402 is configured to: i) suspend an in-progress transaction that is actively being processed on the transaction terminal 400 in response to receipt of a transaction transfer or transaction merge operation request, ii) obtain a target transaction terminal identifier for a target transaction terminal, and iii) provide transaction details for the in-progress transaction and the target transaction terminal identifier to the transfer agent 403.

The transfer agent 403 is configured to: provide the transaction details and a transaction operation identifier for a transaction operation associated with the transaction transfer or transaction merge operation request to the target transaction terminal based on the target transaction terminal identifier for completion processing of the in-progress transaction on the target transaction terminal.

It is to be noted that the transaction transfer operation can be automatically generated by the transaction manager (111, 121, and/or 402) and/or the method 200 when a failure is detected with an in-progress transaction, such failure can occur for a variety of reasons, such as a peripheral failure (receipt printer, card reader, scanner, cash drawer, etc.).

It is to be noted that although the various examples presented were within the context of online middleware food service providers, other embodiments of the invention are not so limited, such that any retailer middleware service that sells products other than food can benefit from the teachings presented herein and above.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
identifying a transaction operation request for an in-progress transaction on a first transaction terminal;
suspending the in-progress transaction on the first transaction terminal responsive to the transaction operation request; and
transferring transaction details for the in-progress transaction from the first transaction terminal to a second transaction terminal for completion processing on the second transaction terminal.

2. The method of claim 1, wherein identifying further includes identifying a second transaction terminal identifier for the second transaction terminal within the transaction operation request.

3. The method of claim 2, wherein identifying further includes identifying a transaction operation identifier for a transaction operation within the transaction operation request.

4. The method of claim 3, wherein suspending further includes packaging with transaction details a first transaction terminal identifier for the first transaction terminal and the transaction operation identifier.

5. The method of claim 4, wherein packaging further includes sending the transaction details with first transaction terminal identifier and the transaction operation identifier to the second transaction terminal.

6. The method of claim 5, wherein sending further includes receiving an acknowledgment to accept the transaction operation for processing from the second transaction terminal.

7. The method of claim 5, wherein sending further includes receiving a declination that declines to process the transaction operation from the second transaction terminal.

8. The method of claim 7, wherein receiving the declination further includes rendering a screen on a display of the first transaction terminal requesting that a different target transaction terminal for processing the transaction operation be provided by an operator of the first transaction terminal.

9. The method of claim 8, wherein rendering further includes iterating the identifying of the transaction operation with a third transaction terminal identifier for a third transaction terminal as provided by the operator within a field of the screen associated with the different target transaction terminal.

10. The method of claim 1 further comprising, processing the transaction operation request as a transaction transfer operation that transfers the in-progress transaction from the first transaction terminal to the second transaction terminal for the completion processing.

11. The method of claim 1 further comprising, processing the transaction operation request as a transaction merge operation that merges the in-progress transaction from the first transaction terminal with a second in-progress transaction that is currently being processed on the second transaction terminal for the completion processing.

12. A method, comprising:
receiving transaction details, a transaction operation identifier for a transaction operation, and a target transaction terminal identifier for a target transaction terminal from a source transaction terminal; and
providing the transaction details, a source transaction identifier for the source transaction terminal, and the transaction operation identifier to the target transaction terminal based on the target transaction terminal identifier.

13. The method of claim 12, wherein receiving further includes receiving the transaction details from the source transaction terminal for an in-progress transaction that has not completed and that currently has been suspended on the source transaction terminal.

14. The method of claim 13, wherein receiving further includes identifying the transaction operation as a transaction transfer operation that is transferring the in-progress transaction from the source transaction terminal to the target transaction terminal for completion processing on the target transaction terminal.

15. The method of claim 12 further comprising, receiving an acknowledgement from the target transaction terminal indicating that the target transaction terminal accepted the transaction details for processing on the target transaction terminal responsive to the transaction operation.

16. The method of claim 15 further comprising, providing the acknowledgement to the source transaction terminal.

17. The method of claim 12 further comprising, receiving a declination from the target transaction terminal indicating that the target transaction terminal is unable to process the transaction operation on the target transaction terminal.

18. The method of claim 17 further comprising, providing the declination to the source transaction terminal and requesting that the source transaction terminal provide a different target transaction terminal identifier for a different transaction terminal for processing the transaction operation.

19. A transaction terminal, comprising:
at least one hardware processor configured to execute executable instructions from a non-transitory computer-readable storage medium representing a transaction manager and a transfer agent;
the transaction manager; and
the transfer agent;
wherein the transaction manager is configured to: i) suspend an in-progress transaction that is actively being processed on the transaction terminal in response to receipt of a transaction transfer or transaction merge operation request, ii) obtain a target transaction terminal identifier for a target transaction terminal, and iii) provide transaction details for the in-progress transaction and the target transaction terminal identifier to the transfer agent;
wherein the transfer agent is configured to: provide the transaction details and a transaction operation identifier for a transaction operation associated with the transaction transfer or transaction merge operation request to the target transaction terminal based on the target transaction terminal identifier for completion processing of the in-progress transaction on the target transaction terminal.

20. The transaction terminal of claim 19, wherein the transaction terminal is one of: a Point-Of-Sale (POS) terminal and a Self-Service Terminal (SST).
